(19) United States
(12) Patent Application Publication
(10) Pub. No.: US 2026/0011755 A1
(43) Pub. Date: Jan. 8, 2026

(54) SYSTEM FOR A METHANOL-BASED FUEL CELL

(71) Applicant: Caterpillar Inc., Peoria, IL (US)

(72) Inventors: David Andrew Pierpont, Dunlap, IL (US); Sachin S. Deshmukh, Dunlap, IL (US)

(73) Assignee: Caterpillar Inc., Peoria, IL (US)

(21) Appl. No.: 18/761,521

(22) Filed: Jul. 2, 2024

(51) Int. Cl. H01M 8/04014; B60K 15/03; B60R 16/08; H01M 8/04082; H01M 8/04089; H01M 8/04111; H01M 8/0612; H01M 8/0662; H01M 8/10; H01M 8/1011

(52) U.S. Cl. CPC H01M 8/04014; H01M 8/04097; H01M 8/04111; H01M 8/04201; H01M 8/0618; H01M 8/0662; H01M 8/1011; B60K 15/03; B60R 16/08; H01M 2008/1095; H01M 2250/20

(57) ABSTRACT

Provided herein are systems and methods for using a methanol solution in a fuel cell. A vehicle may include a storage configured to store fuel; a reformer configured to produce hydrogen from the fuel received from the storage; and a fuel cell. The fuel cell may include an anode loop fluidically coupled to the reformer and configured to receive the hydrogen therefrom; and a cathode loop configured to receive oxygen. A catalytic converter arranged downstream from the fuel cell may be configured to recover excess hydrogen from the hydrogen used by the anode loop and to recover excess oxygen from the oxygen used by the cathode loop. The catalytic converter may further supply heat to an expander of a turbo compressor through the reformer.

### TECHNICAL FIELD

The present invention relates generally to the field of fuel cells, including but not limited to a system for a methanol-based fuel cell.

### BACKGROUND

A fuel cell typically generates electricity by combining hydrogen and oxygen in an electrochemical reaction. Hydrogen atoms enter the fuel cell at the anode, where they are split into protons and electrons; the protons move through the electrolyte to the cathode, while the electrons travel through an external circuit, creating an electric current, and at the cathode, they combine with oxygen to form water as a byproduct. Fuel cells thus rely on hydrogen (H₂) for operation, and can receive the H₂ from a variety of sources.

For example, U.S. Pat. No. 6,887,609 describes a fuel cell system and method for operating the fuel cell system. Such a fuel cell system includes a fuel cell unit with an anode and a cathode, a media flow path for supplying substantially pure hydrogen to the anode, a media flow path for the cathode, an anode exhaust-gas flow path, and a cathode exhaust-gas flow path. The flow path of the cathode includes a fan for supplying air to the cathode and the cathode exhaust-gas flow path includes a catalytic burner. The anode exhaust-gas flow path opens into the catalytic burner and/or into the cathode exhaust-gas flow path upstream of the catalytic burner. An expansion machine receives the combined, catalytically converted fuel cell exhaust-gas flow.

### SUMMARY

A first aspect provided herein relates to a vehicle including a storage configured to store fuel, a reformer configured to produce hydrogen from the fuel received from the storage, and a fuel cell. The fuel cell includes an anode loop fluidically coupled to the reformer and configured to receive the hydrogen therefrom, and a cathode loop configured to receive oxygen. The vehicle also includes a catalytic converter arranged downstream from the fuel cell and a turbo compressor including an expander. The catalytic converter recovers excess hydrogen from the hydrogen used by the anode loop and recovers excess oxygen from the oxygen used by the cathode loop. The catalytic converter supplies heat to the expander of the turbo compressor through the reformer.

A second aspect provided herein relates to an energy system for a vehicle including a storage configured to store fuel, a reformer configured to produce hydrogen from the fuel received from the storage, and a fuel cell. The fuel cell includes an anode loop fluidically coupled to the reformer and configured to receive the hydrogen therefrom, and a cathode loop configured to receive oxygen. The energy system also includes a catalytic converter arranged downstream from the fuel cell and a turbo compressor including an expander. The catalytic converter recovers excess hydrogen from the hydrogen used by the anode loop and recovers excess oxygen from the oxygen used by the cathode loop. The catalytic converter supplies heat to the expander of the turbo compressor through the reformer.

A third aspect provided herein relates to a method of using a methanol solution in a fuel cell, the method including producing, by a reformer, hydrogen from fuel received from a storage configured to store the fuel; receiving, by an anode loop of the fuel cell, the hydrogen from the reformer, wherein the anode loop is fluidically coupled to the reformer; receiving, by a cathode loop of the fuel cell, oxygen; recovering, by a catalytic converter arranged downstream from the fuel cell, excess hydrogen from the hydrogen used by the anode loop and excess oxygen used by the cathode loop; and supplying, by the catalytic converter through the reformer, heat to an expander of a turbo compressor of the fuel cell.

### BRIEF DESCRIPTION OF THE DRAWINGS

FIG. 1 is a block diagram of a system for a methanol-based fuel cell, according to an embodiment of the present disclosure;

FIG. 2 is a schematic diagram of anode and cathode loops of a fuel cell system, according to an embodiment of the present disclosure;

FIG. 3 is a schematic diagram of coolant and high voltage loops of a fuel cell system, according to an embodiment of the present disclosure;

FIG. 4 is a flowchart showing a method of operation of a methanol-based fuel cell, according to an embodiment of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, the systems and methods described herein may be configured, designed, or otherwise arranged to utilize a methanol solution as fuel in a turbocharged fuel cell. High temperature (HT)-proton exchange membrane (PEM) fuel cells are an emerging technology that typically operate between and 160° C. and 200° C. These HT-PEM fuel cells offer several benefits over more mature low temperature (LT)-PEM fuel cells, which operate around 70° C. For example, for use in stationary/slow-moving machinery, an HT-PEM fuel cell may be preferable to an LT-PEM fuel cell, as the machinery has limited cooling system capacity and the higher coolant operating temperature of HT-PEM fuel cell systems may facilitate a higher heat rejection potential. Despite their benefits, however, a drawback of an HT-PEM fuel cell is a lower efficiency and power density as compared to an LT-PEM fuel cell.

To close the gap on efficiency and power density between HT-PEM and LT-PEM fuel cell stack technologies, the fuel cell system as described herein includes a turbocharger to improve the gross stack efficiency and power density. The turbocharger may be used to increase the pressure of the cathode and anode loops of the fuel cell system, which increases stack efficiency and power output. Additionally, the turbocharger recovers exhaust heat energy through an expander stage. The cathode side (e.g., the air side) of the stack releases exhaust at a temperature between 160° C. and 200° C., and excess hydrogen exits the anode side (e.g., the fuel side) of the stack. According to the fuel cell system described herein, the excess hydrogen from the anode side is combined with excess oxygen from the cathode side and routed through a hydrogen catalytic converter. The hydrogen catalytic converter releases the hydrogen energy and increases the exhaust temperature to a temperature between 200° C. and 300° C.

According to the system described herein, a fuel cell system which includes the described solution may utilize a methanol solution (e.g., methanol and water) as fuel. The methanol-operated HT-PEM fuel cell system, as described herein, improves power-density by including a turbocharger with a compressor, a turbine, and an electric (or e-) motor in the fuel cell system. The compressor provides compressed air for maintaining desired fuel cell inlet conditions, while the turbine recovers excess energy from the high-temperature cathode exhaust gases of the fuel cell. In order to utilize the methanol solution as fuel, the fuel cell system includes a reformer to convert the methanol solution to hydrogen prior to entering the fuel cell stack. Therefore, in the fuel cell system as described herein, the reformer uses the high-temperature exhaust gas released by the hydrogen catalytic converter as a heat source, which reduces emissions from the fuel cell and improves operational efficiency. The expander stage of the turbocharger recovers remaining heat from the reformer, thus achieving maximum efficiency. Additional aspects of the present disclosure, as well as additional benefits of the present solution, are described in greater detail below.

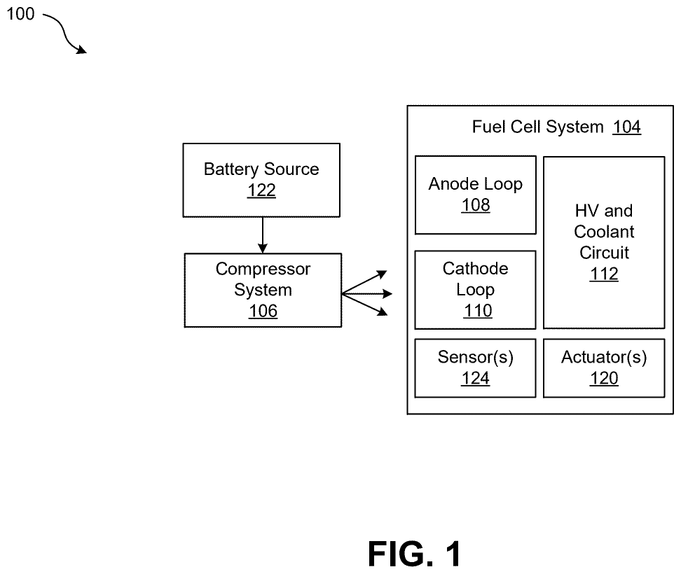

Referring now to FIG. 1, depicted is a block diagram of a system 100 for a methanol-based fuel cell, according to an example implementation of the present disclosure. The system 100 may include a fuel cell system 104 and a compressor system 106. The system 100 may be implemented in various environments or systems. For example, the system 100 may be implemented in various vehicles for supplying power to the vehicle, as a power generation system for homes or businesses (e.g., primary or back-up power), etc. In some embodiments, the system 100 may be implemented in various heavy machinery components or vehicles to supply power thereto.

The fuel cell system 104 may include various types or forms of fuel cells. In some embodiments, the fuel cell system 104 may be or include a proton exchange membrane (PEM) fuel cell. For example, the fuel cell system 104 may be or include a high temperature PEM (HT-PEM) fuel cell (e.g., a fuel cell which operates at high temperatures at fully warm conditions, such as 160° C.) or a low temperature PEM (LT-PEM) fuel cell (e.g., a fuel cell which operates at low temperatures [relative to HT-PEM fuel cells] at fully warm conditions, such as 70° C.). In various embodiments, the fuel cell system 104 may include other types of fuel cells, such as solid oxide fuel cells (SOFCs), molten carbonate fuel cells (MCFCs), alkaline fuel cells (AFCs), phosphoric acid fuel cells (PAFCs), and/or direct methanol fuel cells (DMFCs).

The fuel cell system 104 may include an anode loop 108, a cathode loop 110, and a high voltage (HV) and coolant circuit 112. As described in greater detail below, the anode loop 108 may be configured to be supplied with hydrogen. The cathode loop 110 may be supplied with oxygen. The anode loop 108 and cathode loop 110 may supply the hydrogen and oxygen to a PEM, which converts the hydrogen into protons and electrons, the protons interacting with the oxygen for producing heat and water, and the electrons supplied as power.

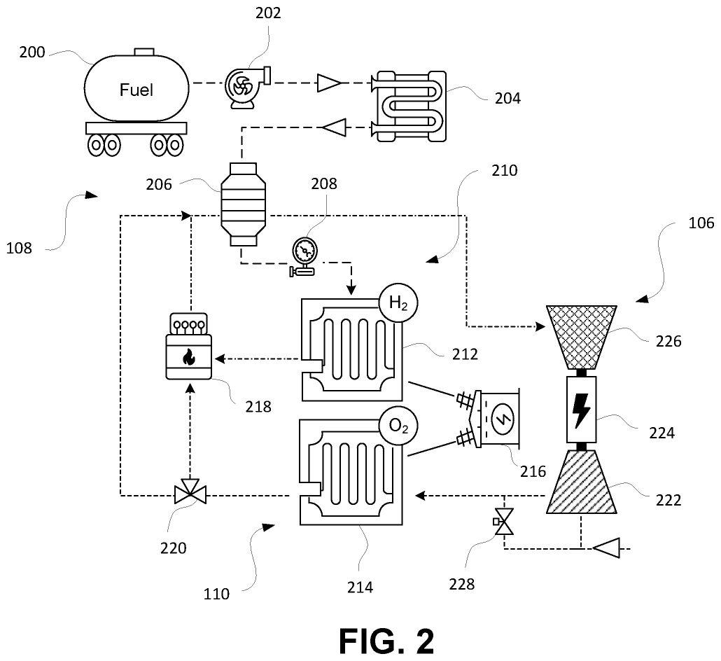

Referring now to FIG. 1 and FIG. 2, the fuel cell system 104 may include the anode loop 108 and the cathode loop 110. Specifically, FIG. 2 is a schematic diagram of anode and cathode loops 108, 110 of the fuel cell system 104, according to an embodiment of the present disclosure. As shown in FIG. 2, the anode loop 108 may include a storage 200 communicably coupled to a fuel pump 202. The storage 200 may be configured to store fuel (e.g., a methanol solution, a hydrogen fuel, etc.). The fuel pump 202 may be configured to pump the fuel from the storage 200 such that the fuel may flow through the anode loop 108. The storage 200 may be further configured to supply or otherwise provide fuel (e.g., the methanol solution) to a reformer 206 through the fuel pump 202.

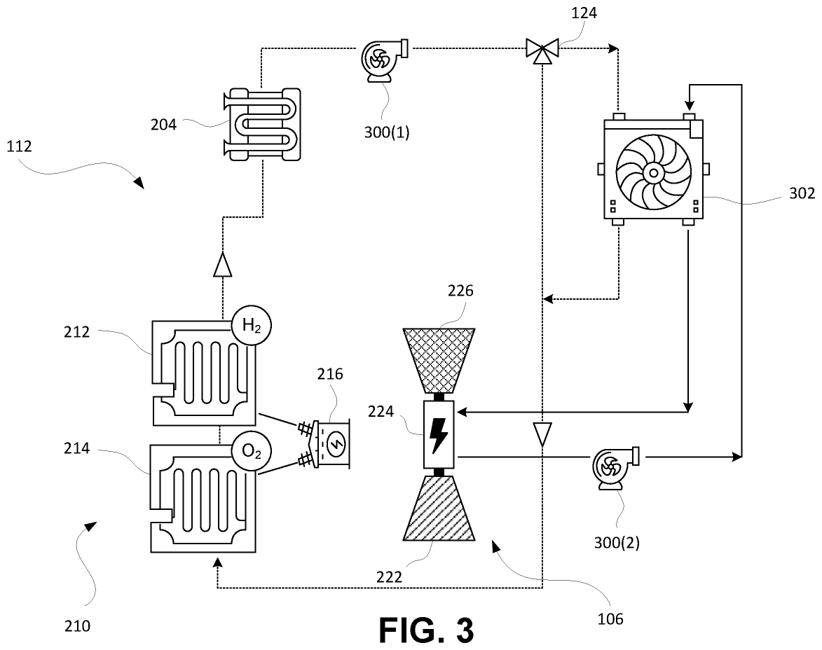

In some embodiments, the fuel provided by the storage 200 to the reformer 206 using the fuel pump 202 first passes through a vaporizer 204. The vaporizer 204 may be arranged between the storage 200 and the reformer 206. The vaporizer 204 may be configured to vaporize the fuel received from the storage 200 such that the fuel supplied to the reformer 206 is a gaseous fuel. For example, in some embodiments, the storage 200 is configured to store the fuel in a liquid state (e.g., a methanol and water solution). Therefore, the vaporizer 204 receives the fuel in the liquid state and is configured to vaporize the fuel from the liquid state to a gaseous state. In some embodiments, as described below with reference to FIG. 3, the vaporizer 204 may be arranged within the HV and coolant circuit 112 such that the HV and coolant circuit 112 is heated by excess heat provided by the vaporizer 204.

The reformer 206 may receive fuel from the storage 200. The reformer 206 may be configured to produce hydrogen from the received fuel (e.g., methanol). In some embodiments, the reformer 206 may be coupled to the vaporizer 204 such that the reformer 206 receives the gaseous fuel from the vaporizer 204. In such embodiments, the reformer 206 may be configured to extract the hydrogen from the gaseous state of the fuel. The reformer 206 may also produce excess heat that may be provided to an expander 226.

As shown in FIG. 2, the reformer 206 may be communicably coupled to a pressure regulator 208. The pressure regulator 208 may be configured to increase, decrease, or otherwise regulate the hydrogen produced by the reformer 206 for supply to a proton exchange membrane (PEM) 210. Specifically, the pressure regulator 208 may be configured to supply the hydrogen to an anode catalyst 212 of the PEM 210. The cathode loop 110 may have air (e.g., ambient air) supplied thereto. Specifically, oxygen from the ambient air may be supplied to a cathode catalyst 214 of the PEM 210. Together, the hydrogen supplied to the anode catalyst 212 and oxygen supplied to the cathode catalyst 214 may operate to produce electrical energy and heat for the fuel cell. More specifically, the hydrogen may be split into protons and electrons at the anode catalyst 212, and the oxygen may combine with the protons and electrons to produce electricity and water, with heat generated as a byproduct. The electrons may flow to an electrical power circuit 216 (e.g., a high-voltage bus) to generate electrical power, while the protons may move through the PEM 210 to facilitate the electrochemical reactions for producing the water and heat.

The anode catalyst 212 may release excess hydrogen, while the cathode catalyst 214 may release excess oxygen at a high temperature. A catalytic converter 218 may receive the excess hydrogen from the anode catalyst 212 and the excess oxygen from the cathode catalyst 214 such that excess exhaust from the PEM 210 may be fed back into the anode loop 108. The catalytic converter 218 may be configured to release heat (e.g., hydrogen energy) from the excess hydrogen received from the anode catalyst 212. The released heat from the catalytic converter 218 may be at a high temperature (e.g., between 200° C. and 300° C.), and may be used as a heat source to power the reformer 206.

As shown in FIG. 2, the cathode loop 110 may include a flow control valve 220. The flow control valve 220 may be coupled to the cathode catalyst 214 and may be used to control a flow of the exhaust (e.g., the excess oxygen) from the cathode catalyst 214. Specifically, the flow control valve 220 may be configured to route the exhaust from the cathode catalyst 214 to the catalytic converter 218 and/or around the catalytic converter 218 (e.g., directly to the reformer 206). For example, the flow control valve 220 may control an air-fuel ratio in the catalytic converter 218 by directing the exhaust from the cathode catalyst 214 to the catalytic converter 218 when the air-fuel ratio is low and by directing the exhaust from the cathode catalyst 214 around the catalytic converter 218 when the air-fuel ratio is high.

Referring to FIG. 1, the fuel cell system 104 may include various actuators 120. The actuators 120 may include pumps, valves, regulators, diverters, or any other actuators designed or configured to control the flow of a fluid. For instance, the cathode loop 110 may include various actuators 120 for regulating the flow of air to or from the cathode catalyst 214. For example, the cathode loop 110 may include to flow control valve 220, as described above. As another example, as shown in FIG. 2, the cathode loop 110 may include a recirculation valve 228 for selectively recirculating air back to a compressor 222. In some embodiments, the cathode loop 110 may include the recirculation valve 228 arranged to supply heated air from the compressor 222 (e.g., output by the compressor 222) back to an input of the compressor 222. In such an example, at least a portion of the heated air may be heated twice, then re-output by the compressor 222 towards the cathode catalyst 214.

Similarly, the anode loop 108 may include various actuators 120 for controlling the flow of hydrogen to the anode catalyst 212. For example, the anode loop 108 may include the pressure regulator 208 and the catalytic converter 218. Additionally, as described in greater detail below with reference to FIG. 3, the HV and coolant circuit 112 may include various actuators 120 for controlling the flow of coolant. For example, the HV and coolant circuit 112 may include various pumps 300 (e.g., 300(1), 300(2)) and a thermostat 124 with an included actuator, for controlling the flow of coolant through the coolant circuit 112.

Referring to FIG. 1, the system 100 may include a compressor system 106. In various embodiments, the compressor system 106 may be or include a turbo compressor system. The compressor system 106 may be communicably coupled to the fuel cell system 104 and powered by a battery source 122. In this regard, the compressor system 106 may be or include an eTurbo (e.g., an electric turbo) compressor system. The battery source 122 may be an external battery source separate from the electrical power circuit 216. In some embodiments, the battery source 122 may be charged by or using electrical power of the electrical power circuit 216.

As shown in FIG. 2, the compressor system 106 may include the compressor 222, a turbo charger 224, and an expander 226. The compressor 222 may receive air input and compress the air to supply pressurized, and correspondingly heated, air to the cathode catalyst 214. The turbo charger 224 may be configured to use or leverage energy from the flow of exhaust gases from the system 100 to drive the compressor 222 (e.g., together with the battery source 122). The expander 226 may be configured to recover some of the energy from the pressurized gas. In some embodiments, the flow control valve 220 may divert air from the compressor 222 (e.g., received first by the cathode catalyst 214) to the expander 226 through the reformer 206.

Referring now to FIG. 1 and FIG. 3, the fuel cell system 104 may include the HV and coolant circuit 112. More specifically, FIG. 3 is a schematic diagram of the HV and coolant circuit 112 of the fuel cell system 104, according to an embodiment of the present disclosure. The HV and coolant circuit 112 may include various pumps 300 (e.g., 300(1), 300(2)) for pumping coolant through the coolant circuit. For example, a first pump 300(1) may pump high temperature coolant through the PEM 210, and a second pump 300(2) may pump low temperature coolant from the compressor system 106 through the HV and coolant circuit 112. Additionally, the HV and coolant circuit 112 may include the vaporizer 204 such that the HV and coolant circuit 112 may be heated by excess heat produced by the vaporizer 204.

As shown in FIG. 3, the HV and coolant circuit 112 may include a heat exchanger 302. The heat exchanger 302 may be configured to transfer absorbed heat from the coolant to an external fluid (e.g., air or some other cooling medium) to dissipate heat, and/or preheat incoming coolant. The HV and coolant circuit 112 may include one or more sensor(s) 124 arranged to measure, detect, or otherwise quantify a temperature of coolant of the HV and coolant circuit 112. In some embodiments, the sensor(s) 124 may be or include temperature sensors arranged to measure the temperature of the coolant. For example, the sensor(s) 124 may be a thermostat, which may include a valve for controlling the flow of coolant to the heat exchanger 302.

As shown in FIG. 2 and FIG. 3, the compressor 222 may be arranged to supply compressed (and thus heated) air to the HV and coolant circuit 112. Specifically, as shown in FIG. 2, the compressor 222 may supply compressed and heated air to the cathode catalyst 214 of the PEM 210 (e.g., the air side of the stack of the PEM 210), and as shown in FIG. 3, the high temperature coolant may pump through the cathode catalyst 214. In this regard, by supplying pressurized heated air to the cathode catalyst 214, the compressor 222 is arranged to also supply pressurized heated air to the coolant circuit.

### INDUSTRIAL APPLICABILITY

The systems and methods described herein can be used in various use cases, environments, and settings, including various vehicles for supplying power to the vehicle, as a power generation system for homes or businesses (e.g., primary or back-up power), etc.

In operation, a user operating the vehicle can achieve a methanol-based high-efficiency vehicle using a HT-PEM fuel cell by first providing methanol fuel to the vehicle (e.g., stored in the storage 200). For example, the methanol fuel may include a methanol/water solution. While the vehicle is in operation, the reformer 206 converts the methanol fuel to hydrogen for use in the PEM 210. Rather than wasting excess heat through a vehicle exhaust, the fuel cell system 104 recovers the excess heat from the PEM 210. That is, excess hydrogen from the anode catalyst 212 and excess oxygen from the cathode catalyst may be routed to the catalytic converter 218. The catalytic converter 218 produces heat used as a heat source for the reformer 206, enabling the reformer 206 to continue converting the methanol fuel from the storage 200 to hydrogen using in the PEM 210 while the vehicle is in operation. Excess heat from the reformer 206 may also be routed to the expander 226 of the compressor system 106 (e.g., eTurbo). Therefore, according to such a system, the vehicle maintains maximum efficiency by recovering exhaust for use in the reformer 206 and the compressor system 106.

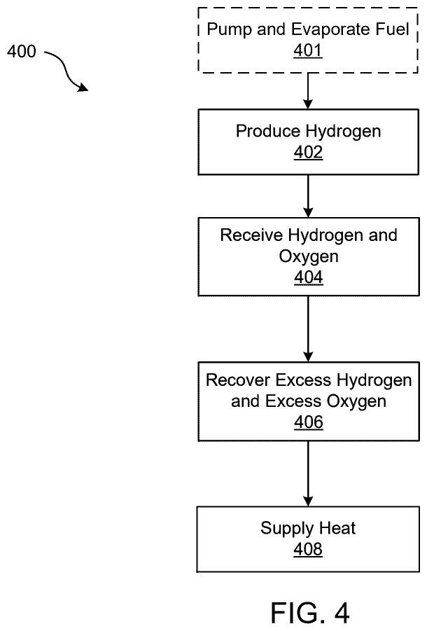

Referring now to FIG. 4, depicted is a flowchart showing an example method 400 of an operation of a methanol-based fuel cell, according to an example implementation of the present disclosure. The method 400 may be performed by, implemented on, or otherwise executed by the components, elements, or hardware described above with reference to FIG. 1 through FIG. 3. For example, the method 400 may be executed by the fuel cell system 104 of FIG. 1. As a brief overview, at step 401, the fuel pump 202 may pump and the vaporizer 204 may vaporize fuel (e.g., a methanol solution) received from the storage 200 of the fuel cell system 104. At step 402, the reformer 206 of the fuel cell system 104 may produce hydrogen. At step 404, the anode loop 108 of the fuel cell system 104 may receive hydrogen and the cathode loop 110 of the fuel cell system 104 may receive oxygen. At step 406, the catalytic converter 218 of the fuel cell system 104 may recover excess hydrogen and excess oxygen. At step 408, the catalytic converter 218 may supply heat to the compressor system 106.

At step 401, the fuel pump 202 may pump and the vaporizer 204 may vaporize fuel (e.g., a methanol solution) received from the storage 200 of the fuel cell system 104. As described herein, the vaporizer 204 may be arranged between the storage 200 and the reformer 206. That is, the vaporizer 204 may be configured to vaporize the fuel received from the storage 200 such that the fuel supplied to the reformer 206 is a gaseous fuel. For example, in some embodiments, the storage 200 is configured to store the fuel in a liquid state (e.g., a methanol and water solution). Therefore, at step 401, the vaporizer 204 receives the fuel in the liquid state and is configured to vaporize the fuel from the liquid state to a gaseous state.

At step 402, the reformer 206 of the fuel cell system 104 may produce hydrogen. The reformer 206 may receive fuel from the storage 200 and may be configured to produce hydrogen from the received fuel (e.g., methanol or methanol solution). In some embodiments, the reformer 206 may be coupled to the vaporizer 204 such that the reformer 206 receives the gaseous fuel that is vaporized by the vaporizer 204 at step 401. In such embodiments, the reformer 206 may be configured to extract the hydrogen from the gaseous state of the fuel.

At step 404, the anode loop 108 fuel cell system 104 may receive hydrogen and the cathode loop 110 of the fuel cell system 104 may receive oxygen. The hydrogen may be provided by the reformer 206 after the hydrogen is produced at step 402. In some embodiments, as shown in FIG. 2, the reformer 206 may be communicably coupled to a pressure regulator 208. Specifically, the pressure regulator 208 may be configured to supply the hydrogen from the reformer 206 to the anode loop 108 (e.g., the anode catalyst 212) of the PEM 210. The cathode loop 110 may have air (e.g., ambient air) supplied thereto at step 404. Specifically, oxygen from the ambient air may be supplied to a cathode catalyst 214 of the PEM 210. Together, the hydrogen supplied to the anode catalyst 212 and oxygen supplied to the cathode catalyst 214 may operate to produce electrical energy and heat for the fuel cell, as described herein.

At step 406, the catalytic converter 218 of the fuel cell system 104 may recover excess hydrogen and excess oxygen. The anode catalyst 212 may release excess hydrogen, while the cathode catalyst 214 may release excess oxygen at a high temperature. A catalytic converter 218 may receive the excess hydrogen from the anode catalyst 212 and the excess oxygen from the cathode catalyst 214 such that excess exhaust from the PEM 210 may be fed back into the anode loop 108. The catalytic converter 218 may be configured to release heat (e.g., hydrogen energy) from the excess hydrogen received from the anode catalyst 212. The released heat from the catalytic converter 218 may be at a high temperature (e.g., between 200° C. and 300° C.), and may be used as a heat source to power the reformer 206.

At step 408, the catalytic converter 218 may supply heat to the compressor system 106. Specifically, as shown in FIG. 2, the catalytic converter 218 may be configured to supply heat to the expander 226 of the compressor system 106 through the reformer 206. In some embodiments, the flow control valve 220 may be configured to route the exhaust from the cathode catalyst 214 to the catalytic converter 218. The reformer 206 may also produce excess heat while producing the hydrogen at step 402, as described above, that may be provided to the expander 226 of the compressor system 106.

Beneficially, the systems and methods described herein can improve the efficiency and power density of HT-PEM fuel cells. By using the systems and methods described herein, a turbo-charged methanol-based fuel cell may improve on the efficiency of operation of vehicles that employ HT-PEM fuel cells.

What is claimed is:

1. A vehicle, comprising:
storage configured to store fuel;
a reformer configured to produce hydrogen from the fuel received from the storage;
a fuel cell comprising:
an anode loop fluidically coupled to the reformer and configured to receive the hydrogen therefrom; and
a cathode loop configured to receive oxygen;
a catalytic converter arranged downstream from the fuel cell, the catalytic converter configured to recover excess hydrogen from the hydrogen used by the anode loop and to recover excess oxygen from the oxygen used by the cathode loop; and
a turbo compressor comprising an expander,
wherein the catalytic converter supplies heat to the expander of the turbo compressor through the reformer.

2. The vehicle of claim 1, further comprising a vaporizer arranged between the storage and the reformer, the vaporizer configured to vaporize the fuel to supply gaseous fuel to the reformer.

3. The vehicle of claim 2, further comprising a fuel pump configured to pump the fuel from the storage to the vaporizer.

4. The vehicle of claim 2, further comprising a coolant line passing through the fuel cell and through the vaporizer, the coolant line being heated by excess heat provided by the fuel cell.

5. The vehicle of claim 2, wherein the storage is configured to store the fuel in a liquid state, wherein the vaporizer is configured to vaporize the fuel from the liquid state to a gaseous state, and wherein the reformer is configured to extract the hydrogen from the fuel in the gaseous state.

6. The vehicle of claim 5, wherein the fuel comprises methanol fuel.

7. The vehicle of claim 1, further comprising a flow control valve arranged downstream from the cathode loop, the flow control valve configured to regulate the recovered oxygen from the cathode loop supplied to the catalytic converter and the reformer.

8. The vehicle of claim 7, wherein the flow control valve regulates a supply of the recovered oxygen to the catalytic converter according to an amount of recovered excess hydrogen.

9. The vehicle of claim 1, wherein the turbo compressor further comprises a compressor configured to supply pressurized oxygen to the cathode loop, the vehicle further comprising:
a recirculation valve arranged downstream from the compressor of the turbo compressor, the recirculation valve configured to supply pressurized oxygen from the compressor back to an intake of the compressor.

10. An energy system for a vehicle, the energy system comprising:
storage configured to store fuel;
a reformer configured to produce hydrogen from the fuel received from the storage;
a fuel cell comprising:
an anode loop fluidically coupled to the reformer and configured to receive the hydrogen therefrom; and
a cathode loop configured to receive oxygen;
a catalytic converter arranged downstream from the fuel cell, the catalytic converter configured to recover excess hydrogen from the hydrogen used by the anode loop and to recover excess oxygen from the oxygen used by the cathode loop; and
a turbo compressor comprising an expander,
wherein the catalytic converter supplies heat to the expander of the turbo compressor through the reformer.

11. The energy system of claim 10, further comprising a vaporizer arranged between the storage and the reformer, the vaporizer configured to vaporize the fuel to supply gaseous fuel to the reformer.

12. The energy system of claim 11, further comprising a fuel pump configured to pump the fuel from the storage to the vaporizer.

13. The energy system of claim 11, further comprising a coolant line passing through the fuel cell and through the vaporizer, the coolant line being heated by excess heat provided by the fuel cell.

14. The energy system of claim 11, wherein the storage is configured to store the fuel in a liquid state, wherein the vaporizer is configured to vaporize the fuel from the liquid state to a gaseous state, and wherein the reformer is configured to extract the hydrogen from the fuel in the gaseous state.

15. The energy system of claim 14, wherein the fuel comprises methanol fuel.

16. The energy system of claim 10, further comprising a flow control valve arranged downstream from the cathode loop, the flow control valve configured to regulate the recovered oxygen from the cathode loop supplied to the catalytic converter and the reformer.

17. The energy system of claim 16, wherein the flow control valve regulates a supply of the recovered oxygen to the catalytic converter according to an amount of recovered excess hydrogen.

18. The energy system of claim 10, wherein the turbo compressor further comprises a compressor configured to supply pressurized oxygen to the cathode loop, the energy system further comprising:
a recirculation valve arranged downstream from the compressor of the turbo compressor, the recirculation valve configured to supply pressurized oxygen from the compressor back to an intake of the compressor.

19. A method of using a methanol solution in a fuel cell, the method comprising:
producing, by a reformer, hydrogen from fuel received from a storage configured to store the fuel;
receiving, by an anode loop of the fuel cell, the hydrogen from the reformer, wherein the anode loop is fluidically coupled to the reformer;
receiving, by a cathode loop of the fuel cell, oxygen;
recovering, by a catalytic converter arranged downstream from the fuel cell, excess hydrogen from the hydrogen used by the anode loop and excess oxygen used by the cathode loop; and
supplying, by the catalytic converter through the reformer, heat to an expander of a turbo compressor of the fuel cell.

20. The method of claim 19, further comprising:
pumping, by a fuel pump, the fuel from the storage to a vaporizer, wherein the vaporizer is arranged between the storage and the reformer;
evaporating, by the vaporizer, the fuel received from the storage, such that the vaporizer supplies gaseous fuel to the reformer; and
heating, by excess heat provided by the fuel cell, a coolant line passing through the fuel cell.
